(19) United States
(12) Patent Application Publication
(10) Pub. No.: US 2026/0073174 A1
(43) Pub. Date: Mar. 12, 2026

(54) MULTI-SIM BASED SHARED SYNCHRONIZATION IN WIRELESS NETWORKS

(71) Applicants: Raziq Yaqub, lumberton, NJ (US); Brian Gordaychik, columbus, NJ (US)

(72) Inventors: Raziq Yaqub, lumberton, NJ (US); Brian Gordaychik, columbus, NJ (US)

(21) Appl. No.: 19/388,278

(22) Filed: Nov. 13, 2025

Related U.S. Application Data
(63) Continuation of application No. 19/173,874, filed on Apr. 9, 2025.
(60) Provisional application No. 63/658,823, filed on Jun. 11, 2024.
(60) Provisional application No. 63/676,366, filed on Jul. 27, 2024.
(60) Provisional application No. 63/718,826, filed on Nov. 11, 2024.

(51) Int. Cl. G06K 19/07; G06K 7/00; G06K 7/10; H04L 27/26

(52) U.S. Cl. CPC G06K 19/0723; G06K 7/0008; G06K 7/10019; H04L 27/2607

(57) ABSTRACT

A multiple subscriber identity module (multi-SIM) compliant user equipment (UE), comprising: a first SIM; a second SIM which is different than the first SIM; a transceiver configured to receive a synchronization signal block (SSB) associated with a first network, based on information of the first SIM; the transceiver configured to perform initial access and to establish a connection with the first network; the transceiver configured to transmit a data signal for processing by a second network, wherein the signal is transmitted based on the established connection with the first network; wherein communication with the first network and the second network is based on an overlap in an initial network handshake with the first network and the second network. In embodiments, the UE does not monitor for an SSB on the second network.

### CROSS REFERENCE TO RELATED APPLICATIONS

This application is a continuation of U.S. patent application Ser. No. 19/173,874 filed on Apr. 9, 2025 which claims the benefit of U.S. Provisional Patent Application Nos. 63/658,823 filed on Jun. 11, 2024, 63/676,366 filed on Jul. 27, 2024 and 63/718,826 filed on Nov. 11, 2024, the contents of each of where are incorporated by reference herein.

### SUMMARY

A multiple subscriber identity module (multi-SIM) compliant user equipment (UE), comprising: a first SIM; a second SIM which is different than the first SIM; a transceiver configured to receive a synchronization signal block (SSB) associated with a first network, based on information of the first SIM; the transceiver configured to perform initial access and to establish a connection with the first network; the transceiver configured to transmit a data signal for processing by a second network, wherein the signal is transmitted based on the established connection with the first network; wherein communication with the first network and the second network is based on an overlap in an initial network handshake with the first network and the second network. In embodiments, the UE does not monitor for an SSB on the second network.

### BRIEF DESCRIPTION OF THE DRAWINGS

FIG. 1 is an illustration of multiple subscriber identity module (multi-SIM) approaches to inter-network cooperation;

FIG. 2 illustrates a multi-TRP embodiment wherein TRPs vary a beam width for transmission of SSB; and

FIG. 3 is a multi-TRP illustration of a wireless device receiving transmissions of multiple TRPs simultaneously.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

In embodiments, SSBs may provide information as to the sharing availability of a base station or TRP, for example, by providing an indication of the coexisting core network operators and functionality of each, such that only one SIM need perform SSB detection initially. Such information may be passed electronically from SIM to SIM. In embodiments, the dual pair may receive information on an agreement from one or both operators and each one of the two operators may send a signal regarding one or both SIMs. Dual SIM may allow for the provisioning based on the presence or absence of an agreed upon sharing signal indication received from the network. Each network may sell an add on SIM for a given price such that the secondary SIM is used only for a given priority level or for when a secure communication (e.g. post quantum communication) is required.

A UE may or may not monitor for SSB based on one or more conditions disclosed herein.

Multiple SIMs may be used in a joint manner, for example, one SIM may make a remote procedure call based on information of the other SIM or a registration procedure that is performed by the secondary or other SIM. SIM cards may have access to shared memory on the UE or at a network element.

Two new network entities are proposed: the Inter-network Resource Sharing (IRS) Gateway and the SIM Interaction Mapping Server (SIMSer). The IRS Gateway will facilitate seamless communication between networks of pertinent SIMs, while the SIMSer will manage and maintain a comprehensive database of SIM mappings. This architecture is complemented by the development of several new types of RAN (Radio Access Network) and Core Network messages, enabling efficient interaction between SIMs and optimized use of radio resources.

The implementation of these new network entities conserves radio resources by minimizing duplicate signaling and optimizing resource allocation. Despite the challenges associated with complexity, initial costs, and standardization, the potential benefits in terms of resource conservation and enhanced efficiency make this approach a compelling avenue for future advancements in mobile communication systems.

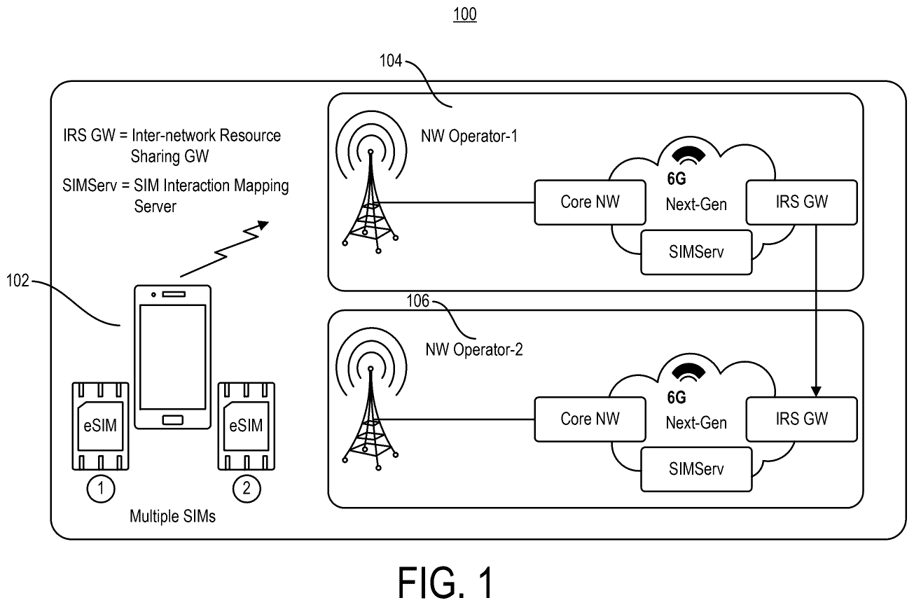

FIG. 1 is an illustration 100 of multiple subscriber identity module (multi-SIM) approaches to inter-network cooperation.

The mobile communication industry has experienced a significant shift with the increasing adoption of multi-SIM phones 102. Multi-SIM functionality allows users to leverage different network operators, e.g. operator 1 104 and operator 2 106, and plans within a single device, thereby enhancing flexibility and connectivity. Users can maintain separate SIM cards for work and personal use, benefit from better coverage, and take advantage of different pricing plans to optimize costs. However, the current architecture, where SIM cards operate independently, leads to inefficiencies such as duplicate signaling and underutilization of radio resources. Each SIM card independently manages registration, authentication, and other signaling procedures, often leading to redundant processes that consume valuable network and device resources. This redundancy not only affects the battery life of the device but also contributes to unnecessary network congestion.

To address these inefficiencies, this proposal introduces a novel approach involving the introduction of two new network entities: the Inter-network Resource Sharing (IRS) Gateway and the SIM Interaction Mapping Server (SIMSer). The IRS Gateway aims to optimize resource allocation by enabling resource sharing between different network operators, thereby reducing duplicate signaling and improving overall network efficiency. Meanwhile, the SIMSer is designed to manage interactions between multiple SIM cards within a device, coordinating their activities to minimize redundant processes and enhance battery life. By mapping and optimizing the interactions of SIM cards, the SIMSer ensures that only necessary signaling is performed, thereby reducing the overall signaling load on the network. This innovative approach promises to significantly enhance the performance and efficiency of multi-SIM phones, providing a superior user experience while optimizing network resources.

Below, we delve into the specifics of the Inter-network Resource Sharing (IRS) Gateway and the SIM Interaction Mapping Server (SIMSer), detailing their roles and the transformative impact they will have on the mobile communication landscape.

### Functionalities of the Inter-Network Resource Sharing (IRS) Gateway

The IRS Gateway plays a pivotal role in the proposed architecture by facilitating seamless communication and resource optimization between networks associated with multi-SIMs in a single UE (User Equipment). The primary functionality of the IRS Gateway is to mediate interactions between different mobile networks pertinent to the involved SIMs, ensuring efficient utilization of radio resources by the multi-SIM carrying UE and minimizing redundant signaling. By establishing a centralized point for managing inter-network communications, the IRS Gateway enables real-time coordination between operators, leading to improved network performance and resource conservation.

One of the key functions of the IRS Gateway is to handle the SIM Interaction Setup process. When a UE with multi-SIMs initiates a request for inter-network cooperation, the IRS Gateway receives the interaction request and validates the credentials and parameters of the involved SIMs through communication with the SIMSer, as explained in the next section. This validation process involves checking the authentication details, subscription profiles, and network policies to ensure compliance and security.

Upon successful validation, the IRS Gateway coordinates with the core networks of both SIMs to establish a synchronized communication session. This process involves exchanging essential parameters such as encryption keys, QoS (Quality of Service) requirements, and priority settings. The IRS Gateway sets up a secure interaction session ID, ensuring that both networks are aware of the ongoing cooperation and can manage resources accordingly. Additionally, the IRS Gateway facilitates the negotiation of bandwidth allocation, latency requirements, and handover parameters to optimize the session's performance.

Moreover, the IRS Gateway plays a vital role in maintaining the session by continuously monitoring the interaction and facilitating the transfer of data. It dynamically adjusts resource allocation based on real-time network conditions, ensuring that the UE receives the best possible service without overloading any single network. This involves sophisticated algorithms for load balancing and interference management, which enhance overall network efficiency.

The IRS Gateway also supports advanced features such as adaptive scheduling and predictive resource management. By analyzing historical data and usage patterns, it can anticipate network demands and pre-emptively allocate resources, further reducing latency and improving user experience. In case of any disruptions or changes in network conditions, the IRS Gateway can seamlessly switch between networks, maintaining uninterrupted service.

### Functionalities of the SIM Interaction Mapping Server (SIMSer)

The SIMSer is a critical component in the proposed architecture, responsible for maintaining and managing the database of SIM mappings. Its primary functionality is to store, update, and retrieve mapping information for SIMs across different networks, ensuring that each SIM interaction request is accurately mapped, processed, and validated. SIMSer acts as a central repository that holds detailed records of SIM identifiers, network affiliations, and interaction permissions, providing a robust framework for managing inter-network communications.

When a UE with multi-SIMs initiates a SIM Interaction Request, the SIMSer receives a mapping request from the IRS Gateway. This request includes essential information such as the source IMSI/IMEI, target alias/phone number, and the type of interaction required. The SIMSer performs a detailed look up in its database to validate the interaction and retrieve the corresponding mapping information. This validation process ensures that the interaction is authorized and complies with predefined network policies, including security protocols and access controls. The SIMSer uses advanced algorithms to match the SIM details with the correct network configurations and permissions, ensuring seamless inter-network communication.

Once the validation process is complete, the SIMSer communicates the relevant mapping details back to the IRS Gateway. This communication includes encrypted interaction parameters and session initiation protocols that facilitate the setup of a secure and efficient communication session between the networks of the involved SIMs. The SIMSer along with PCF (Policy and Charging Function) plays a vital role in ensuring that both networks involved adhere to the agreed terms of interaction. This involves negotiating terms such as bandwidth allocation, priority levels, and service quality, ensuring that the interaction is optimized for both performance and security.

Additionally, the SIMSer continuously updates its database to reflect changes in SIM configurations, network affiliations, and interaction policies. This dynamic updating process is crucial for maintaining the accuracy and reliability of the SIM mappings, allowing the system to adapt to changes in real-time. The SIMSer employs machine learning techniques to predict and preemptively resolve potential conflicts or inefficiencies in SIM interactions, further enhancing the system's robustness and performance.

By centralizing the management of SIM mappings, the SIMSer significantly enhances the accuracy and reliability of inter-network interactions. This centralization not only streamlines the validation and setup process but also facilitates more effective resource allocation by providing real-time insights into network usage patterns and demands. The SIMSer's ability to manage and optimize these interactions contributes to improved overall network performance, reduced latency, and enhanced user experience, making it an indispensable component in the proposed multi-SIM architecture.

### Messaging Protocols for Initial Registration and Authentication Procedure

In order to facilitate seamless interaction and cooperation between multi-SIMs across different networks, the introduction of new types of RAN (Radio Access Network) and Core Network messages is essential. These messages are specifically designed to support the proposed functionalities of the IRS Gateway and SIMSer, enabling efficient communication, resource sharing, and coordination between disparate network entities. The new messaging protocols aim to optimize overall network performance by reducing redundant signaling and enhancing the management of radio resources.

The new types of RAN and Core Network messages will include, but are not limited to, SIM Interaction Request (SIR), SIM Interaction Acknowledgement, SIM Interaction Mapping Request (SIMR), SIM Interaction Mapping Response, SIM Interaction Setup (SIS), SIM Interaction Confirmation (SIC), SIM Interaction Data Transfer, SIM Interaction Termination Request, and SIM Interaction Termination Confirmation. These messages will ensure that each stage of the SIM interaction process, from initial request to final confirmation, is meticulously handled, providing a structured and efficient framework for inter-network cooperation. These new message types are explained below:

### Registration and Authentication

Both SIMs (SIM-1 and SIM-2) register with their respective networks using standard procedures. During this phase, each SIM undergoes the typical authentication process, where the mobile network verifies the subscriber's credentials. This step ensures that both SIMs are authenticated and authorized to access the network services. The registration process involves exchanging signaling messages such as Attach Request and Attach Accept, which confirm the successful attachment of the SIMs to their respective networks.

### Automatic Detection and Initialization

When the User Equipment (UE) detects the presence of two SIMs, it automatically initiates a SIM Interaction Request (SIR) to the base station of SIM-1's network. This detection is facilitated by the UE's internal software, which identifies multiple active SIMs and triggers the interaction setup process. The automatic initialization ensures that the UE can manage multi-SIM interactions without user intervention, streamlining the process for seamless communication.

### SIM Interaction Request (SIR)

The SIR is sent from the UE to the base station of SIM-1's network, which forwards it to SIM-1's home network core. This message contains information about the presence of SIM-2 and requests the initiation of inter-network cooperation. The SIR includes the IMSI of SIM-1, the identifier of SIM-2, and the type of interaction required. This request is crucial for setting the groundwork for resource sharing and efficient communication between the two networks.

### SIM Interaction Acknowledgement (SIA)

The SIM-1's core network sends an acknowledgement back to the UE, confirming the receipt of the interaction request. The SIA message assures the UE that the request has been received and is being processed. This acknowledgement is essential for maintaining synchronization between the UE and the network during the interaction setup phase.

### SIM Interaction Mapping Request (SIMR)

SIM-1's core network sends a mapping request to the IRS Gateway. The SIMR message includes details such as the IMSI of SIM-1, the target network identifier, and the specific interaction requirements. This request is forwarded to the IRS Gateway, which acts as the intermediary for coordinating the interaction between the two networks.

### SIM Interaction Mapping Response (SIMR)

The Interaction Mapping Server (IMSer) provides the necessary details and validation for SIM-2. The SIMR response includes mapping information such as the validated credentials of SIM-2, interaction permissions, and any other relevant parameters required for establishing the inter-network communication. This response ensures that both SIMs are authorized and the interaction complies with network policies.

### Coordination With SIM-2's Network

The IRS Gateway communicates with SIM-2's core network to facilitate the interaction setup. This coordination involves exchanging information about the interaction requirements and ensuring that both networks are prepared for the upcoming communication session. The IRS Gateway ensures that the resource allocation and network parameters are synchronized between the two networks.

### SIM Interaction Setup (SIS)

The IRS Gateway coordinates the setup by sending connection parameters to both core networks. The SIS message includes details such as encryption keys, session IDs, and other necessary parameters for establishing a secure and efficient communication session. This setup phase ensures that both networks are aware of the interaction and can manage their resources accordingly.

### SIM Interaction Confirmation (SIC)

Both core networks confirm the interaction setup to SIM-1 and SIM-2. The SIC message provides confirmation that the interaction setup is complete, and the communication session can proceed. This confirmation is crucial for synchronizing the networks and ensuring that both SIMs can start the data transfer phase.

### SIM Interaction Data Transfer (SIDT)

Data transfer occurs between SIM-1 and SIM-2 through their respective core networks. The SIDT messages facilitate the exchange of data, ensuring that the communication is efficient and optimized for resource utilization. This phase involves transferring user data, signaling information, and any other necessary communication between the two networks.

### SIM Interaction Termination Request (SITR)

If either SIM needs to terminate the interaction, a termination request is sent to the core network. The SITR message initiates the termination process, signaling that the communication session should be closed. This request includes details such as the session ID and the reason for termination.

### SIM Interaction Termination Confirmation (SITC)

Both core networks confirm the termination of the interaction to SIM-1 and SIM-2. The SITC message ensures that the termination process is complete and both networks have released the resources allocated for the interaction. This confirmation is crucial for maintaining network efficiency and ensuring that resources are available for other communication sessions.

### Messaging Protocols for Call Setup Procedure

Below, we outline the messaging protocols for a call setup procedure that enable the advanced level of resource optimization.

### Call/Session Request Initiation

When a User Equipment (UE) initiates a call or data session, it sends a Call/Session Request over the air interface to the primary network associated with one of its SIMs. This request contains information about the type of session (voice, video, data), the requested Quality of Service (QoS), and other relevant parameters. The primary network's base station receives this request and forwards it to the IRS Gateway.

The IRS Gateway, upon intercepting the Call/Session Request, checks if the requested resources can be optimized by leveraging the secondary network associated with the other SIM. This step involves analyzing the current network load, resource availability, and potential benefits of offloading some traffic to the secondary network.

### Resource Coordination Message (RCM)

The IRS Gateway sends a Resource Coordination Message (RCM) to the SIMSer to retrieve the mapping and resource status of both SIMs. The RCM includes details such as the requested QoS, available bandwidth, and the current load on each network. This message is crucial for assessing the feasibility of resource optimization.

The RCM also contains identifiers for both SIMs, ensuring that the SIMSer can accurately match the request with the corresponding SIM profiles and network conditions. This coordination ensures that the resource allocation plan is based on real-time data and network status.

### Resource Availability Check

The SIMSer processes the RCM and performs a lookup in its database to check the resource availability and current network conditions for both SIMs. The database contains detailed records of network resources, load metrics, and historical usage patterns.

The SIMSer responds with a Resource Availability Report (RAR), which includes detailed information about available radio resources and optimal allocation strategies for the requested session. The RAR provides a comprehensive overview of network conditions, enabling informed decision-making.

### Resource Allocation Decision

Based on the RAR, the IRS Gateway decides the best resource allocation strategy to minimize duplicate signaling and conserve radio resources. This decision involves analyzing various factors such as network load, resource utilization efficiency, and the potential impact on QoS.

The IRS Gateway may choose to use the primary network for voice/data traffic while offloading background or less critical data to the secondary network, or vice versa. This strategy ensures that critical traffic receives the highest priority and optimal resources.

### Resource Assignment Message (RAM)

The IRS Gateway sends a Resource Assignment Message (RAM) to both the primary and secondary networks. The RAM specifies the resource allocation plan, detailing which portions of the traffic each network will handle.

The networks adjust their resource allocation accordingly and prepare to handle the incoming traffic based on the optimized plan. This preparation involves setting up necessary channels, adjusting bandwidth allocation, and configuring network elements to support the resource distribution.

### Session Establishment

The primary network establishes the call/session based on the RAM instructions. This involves completing the call setup process, allocating resources, and establishing communication channels.

The secondary network, if involved, sets up the necessary channels to handle its designated portion of the traffic. The IRS Gateway monitors the setup process to ensure seamless coordination and efficient resource use. This monitoring includes verifying that the allocated resources are utilized as planned and that there are no conflicts or bottlenecks.

### Dynamic Resource Adjustment

During the session, the IRS Gateway continuously monitors network conditions and resource utilization. This monitoring involves real-time analysis of traffic patterns, network load, and QoS metrics.

If necessary, the IRS Gateway dynamically adjusts resource allocation between the networks to respond to changes in traffic load, QoS requirements, or network performance. This adjustment ensures ongoing optimization and conservation of radio resources throughout the session, maintaining high service quality and efficient network operation. This dynamic adjustment can include reallocating bandwidth, rerouting traffic, and modifying resource assignments based on real-time conditions.

### Dynamic Role Assignment and Resource Optimization for Dual SIM Integration

To further enhance the efficiency and user experience of multi-SIM integrated mobile phones, the assignment of primary and secondary roles can be implemented through both user discretion and network control mechanisms. Users may designate one SIM as the primary for network-intensive activities such as calls, data usage, work mode, and travel mode, while assigning the secondary SIM for less frequent activities like SMS and low-priority notifications. This role assignment can be dynamically switched based on usage patterns and battery levels, providing flexibility and control to the user. For instance, a user might set the work SIM as primary during office hours and the personal SIM as primary during evenings and weekends. This level of control allows users to optimize their mobile experience based on their specific needs and preferences.

Network-controlled role assignment offers an additional layer of optimization by monitoring network conditions such as signal strength and congestion. The network can automatically assign the SIM with better conditions as the primary, thus reducing roaming charges, failed attempts, and re-transmissions. For example, if the primary SIM's network is experiencing high congestion or poor signal quality, the network can seamlessly switch the primary role to the secondary SIM that has better connectivity. This not only lowers costs but also conserves power, ensuring a more efficient use of network resources. Additionally, this mechanism can help mitigate issues like network outages by dynamically adjusting SIM roles based on real-time conditions, thereby maintaining continuous service.

Implementing a unified registration process for both SIMs through the primary SIM can significantly reduce signaling overhead. By avoiding separate registration processes for each SIM, the system can streamline network interactions and enhance performance. This unified registration approach means that both SIMs share the same initial network handshake, reducing the number of signaling messages exchanged with the network. This efficiency not only improves network performance but also decreases the likelihood of network congestion and related issues.

Additionally, the primary SIM can stay in active or idle mode, while the secondary SIM remains in a low-power state, waking up only when necessary (e.g., for incoming calls or messages). This approach minimizes power consumption and extends battery life. For example, the secondary SIM can be configured to periodically check for notifications or messages and then return to a low-power state, thereby conserving battery. This intelligent power management ensures that the device remains operational for longer periods, which is especially beneficial for users who rely heavily on their mobile devices throughout the day.

To further optimize resource usage, advanced algorithms can be developed to dynamically adjust the activity levels of each SIM based on factors such as battery levels, usage patterns, and network conditions. These algorithms will ensure that the most efficient use of resources is maintained, providing a seamless and cost-effective user experience. For instance, if the battery level drops below a certain threshold, the algorithm might shift more activities to the secondary SIM to balance power consumption. Additionally, the algorithms can learn from user behavior over time, predicting which SIM will be needed and adjusting roles proactively. This adaptive approach ensures that users enjoy uninterrupted service and optimal performance, regardless of their usage patterns or external conditions.

The proposed solution offers significant benefits in terms of resource optimization and enhanced efficiency. By minimizing duplicate signaling, the solution ensures that radio resources are used more efficiently, which leads to effective resource allocation and conservation of valuable radio spectrum. This optimization is crucial in reducing the overall load on the network and improving the performance of mobile devices. For example, by eliminating the need for each SIM to independently negotiate with the network, the system can significantly reduce the number of signaling messages, which in turn conserves bandwidth and reduces the potential for network congestion.

Additionally, the solution enhances efficiency by enabling seamless inter-network cooperation. This means that SIM cards from different operators can interact seamlessly without unnecessary user intervention, improving the user experience and overall network performance. For instance, when a user with multi-SIMs moves from one coverage area to another, the system can automatically coordinate between networks to ensure continuous connectivity. This seamless transition is achieved without the user needing to manually switch SIMs or adjust settings, providing a more intuitive and hassle-free experience.

Moreover, the ability to dynamically manage and optimize resources between different networks allows for more robust handling of network traffic. In high-demand scenarios, such as during peak hours or in densely populated areas, the system can intelligently allocate resources to maintain service quality. This adaptive resource management not only enhances user satisfaction but also helps operators manage their network resources more effectively, leading to improved overall network stability and performance.

The proposed concept of Inter-network Cooperation and Resource Optimization for smart multi-SIM phones addresses significant inefficiencies in current mobile communication systems. By introducing the IRS Gateway and SIMSer, and developing new RAN and Core Network messages, we aim to revolutionize the way multi-SIM cards operate within a single UE. This approach promises enhanced efficiency, resource conservation, and centralized management, making it a compelling avenue for future advancements in mobile communication systems.

The IRS Gateway facilitates seamless communication and resource optimization between networks, ensuring that radio resources are utilized efficiently and reducing redundant signaling. This centralized management approach allows for real-time coordination between operators, leading to improved network performance and resource conservation. The SIMSer, on the other hand, acts as a critical component for maintaining and managing the database of SIM mappings, ensuring accurate and validated interactions between networks.

Together, these components create a robust framework for inter-network cooperation, enhancing the user experience by providing seamless connectivity and optimized resource usage. The introduction of new messaging protocols further supports this framework, ensuring that every stage of the SIM interaction process is handled efficiently.

Overall, the proposed solution offers a transformative impact on the mobile communication landscape, paving the way for more efficient, reliable, and user-friendly multi-SIM operations. As the mobile industry continues to evolve, innovations such as these will be essential in addressing the growing demands for connectivity and resource management, ultimately leading to a more sustainable and efficient mobile ecosystem.

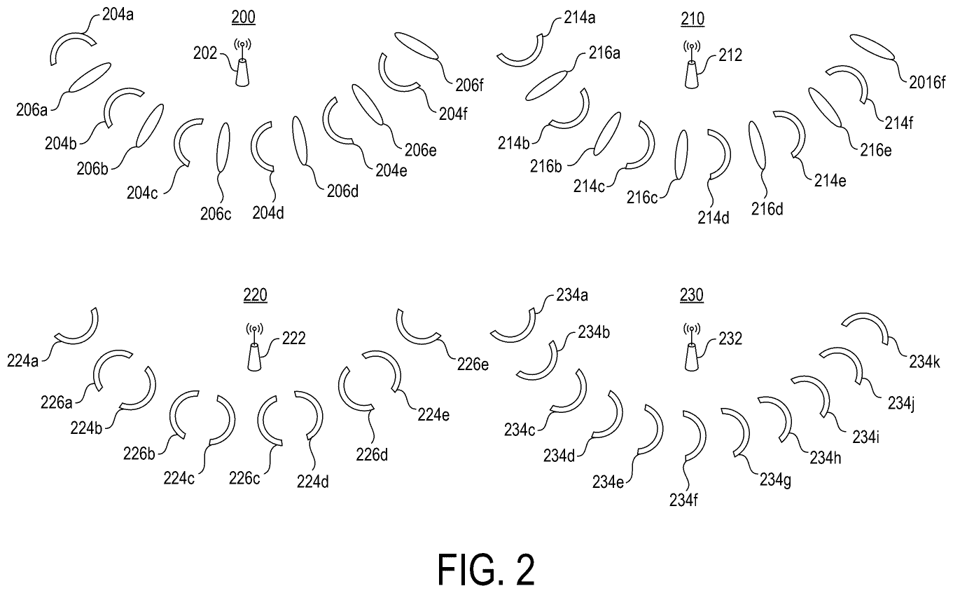

FIG. 2 illustrates a multi-TRP examples 200, 210, 220, 230, wherein TRPs 202, 212, 222, 232 transmit straight line beams and parabolic beams. Example 200 shows a TRP 202 transmits parabolic beams 204a-204f and straight line beams 206a-206f. A straight line beam may immediately follow a parabolic beam transmitted in one direction.

TRP 212 may transmit parabolic beams 214a-214f interspersed with straight line beams 216a-216f. In this way, TRP 212 may transmit a straight line beam following a parabolic beam transmitted in another parabolic direction from TRP 202. The parabolic beams may be of a same shape albeit transmitted at a different angle. TRP 222 shows a transmission scheme 220 wherein parabolic beams are transmitted back to back. A first parabolic beam 224a is transmitted and then another shape parabolic beam 226a is transmitted. In this way parabolic beams 224a-224g are transmitted interspersed with parabolic beams 226a-226g. TRP 236 may transmit all parabolic beams 234a-234k.

Parabolic beams may each be of different shapes, for example having narrower or wider endpoints. In embodiments, a first SSB may comprise all straight beams, while a second SSB performed after the first SSB may be comprised of all parabolic beams or may or may not include some straight beams. Parabolic beams (or other shaped beams) may be employed to promote physical layer security and each beam may be tested accordingly (e.g. based on SNR) and compared to a threshold used for determining whether a recipient may be a legitimate recipient vs an adversary.

SSB transmissions may alternate phase of the parabolic beam such that two immediately transmitted beams are of the same size and amplitude, however they have opposite phases. Phases may be slightly changed at each instance of a transmitted synchronization block. A UE may report a beam quality of a preferred straight line beam only based on capability. A UE may report a parabolic beam only based on capability. Alternatively, some UEs may report both straight beam quality and parabolic beam quality at a fixed or variable time interval after receiving SSB. By monitoring for parabolic beams, a UE may determine an operating frequency, for example, an operating frequence in the THz space and/or ˜7 GHz to ˜20 GHz range and sub-THz space. UEs may perform similar beamforming procedures and transmit beams to base stations. The BS may report beam quality similarly. The UE or BS may detect a timing based on reception of parabolic beams. Both mobile devices and base stations may detect multipaths created by the beams transmitted by the other side and determine delay and doppler parameters. The devices may then combine signals received by each of the multipaths before decoding a combined signal by separating received signals by their angles of departure/reception. By separating each received multipath signal into a channel, each channel may be processed separately (and receive information fed back, e.g. via CSI, to the transmitter) and then combined before decoding. Devices may have to compensate for movement or rotation of the wireless device and/or movement or signal blockage from other devices over time. UEs may, based on frequency parameters, for example, frequency above a threshold frequency, calculate and combine doppler and delay while, on other lower frequencies, not do so. Other loss type parameters may be determined and used in transmission scenarios, for example, geometric loss, atmospheric attenuation, beam scattering and scintillation loss may be estimated and used for conveying data. Loss information may be determined via echo detection.

SSB patterns may be transmitted according to subcarrier spacing, frequency range and/or based on any other parameter disclosed herein and these may convey doppler spread and delay information to a UE. Networks may only use parabolic or rainbow shaped beams in certain frequencies, for example, above THz range. The deflection of each parabola may be modified in time, for example, achieving 360 degree coverage of a UE or base station during synchronization or during data transmission. In embodiments, eNBs may support millimeter wave and higher frequencies using component carrier aggregation (for example, supporting a combination via aggregation of any of the technologies herein). Additionally, FR3 may be supported by certain devices, including frequency ranges of 7.125 ghz to 24.25 ghz.

SSBs may be transmitted in various symbol patterns and these patterns may alternate to convey certain information to a receiver. In embodiments, a first symbol may be a PSS symbol, second symbol may be an SSS symbol, third symbol may convey PBCH and fourth symbol may convey PBCH. Any symbol may occupy more or less space in the frequency domain. For example, a first PBCH symbol may occupy more space in the frequency domain than a second PBCH. Preferably, synchronization signals (which may be beamformed according to narrow beams, wide beams, parabolic beams, or other types of beams), may occupy less of the frequency domain than PBCH. One or more synchronization signals may be parabolic based, while one or more other synchronization signals may not be parabolic based.

SSB design: In embodiments, SSBs may have variable length in the time domain and may be transmitted on demand when UE enters cell. Information about the SSB (including an SSB length) transmitted by a base station may be signaled to another base station, a UE or a group of UEs via DCI or RRC signaling. The UE may assume that certain SSB signals are quasi collocated with another transmission that is made to the UE or to another UE of which the UE is able to detect. For example, a positioning reference signal or another reference signal which is transmitted at a higher frequency and/or more frequently than the SSB signal transmitted by the base station. The SSB may include group specific information, RRC information, DCI information, MAC information etc. The SSB may be group specific and may schedule another SSB transmission which is transmitted directly or on a UE specific basis which is beamformed to the UE.

In embodiments, a UE may receive a group SSB. The UE may decode the group SSB based on a group based RNTI or a RNTI dedicated for UEs which are not associated to the BS but are associated to another BS. The UE may perform positioning, ranging and may compute signal reception quality based on reference signals provided in the group SSB. The group SSB may comprise a data portion which indicates time, frequency and/or beam resources for a subsequent SSB which may be in a different frequency band or portion than the group based SSB. For example, the group based SSB may be on a band in the <1 GHz range, a band in the ˜3-6 GHZ range or a millimeter band and may also be transmitted in frequencies in the 7-15 GHz centimetric range and 90-300 GHz<THz range. Any one or more of the other bands may be used for receiving the UE specific SSB using a UE specific RNTI. There may be certain UEs which are capable of receiving only the group specific or only a UE specific SSB, however, for UEs which are capable of receiving the group specific SSB first, the high capability UEs may receive the UE specific SSB on resources indicated by the group SSB. The UE may transmit an indication that the group SSB was received, wherein the indication may be transmitted on dedicated group specific signaling resources for which other members of a reception group are allowed to use on a CDMA or other manner. Alternatively, or in combination, each UE may transmit on contention based resources an indication that the group based SSB is received. Similarly, when a UE receives the UE specific SSB, the UE may indicate successful reception by transmitting RACH on contention or contention free resources of a same or different frequency band than which the UE specific SSB is received on. UE specific may have a greater or smaller frequency utilization than the group based SSB. UE specific may have a greater or smaller time utilization than the group based SSB. UE specific may have a greater or smaller beam utilization than the group based SSB.

In embodiments, a base station or other transmitter transmits an SSB or group of SSBs in response to cell entry of a UE or based on a wake up signal from another neighboring bs. Some transmitters may begin transmitting SSBs (which may include wake up signal information) using small time/frequency segments at certain beam subsets and then expand into SSB transmissions with larger frequency or time occupations as needed, based on signaling received or not received from devices in range or devices which are anticipated to be in range. In some embodiments, transmitting in additional beams may be used to discover additional users only when those segments are detected as not having formed interference. SSBs and other signals may be transmitted in part or in whole in each one or more of the following frequency ranges: <1 GHz range, ˜3-6 GHZ range and millimeter band and including frequencies in the 7-15 GHz centimetric range and 90-300 GHz<THz range. Other ranges, outside of these ranges, may also be used for SSB and signal transmission.

SSBs and other control signaling, for example, DCI signaling may specify information regarding gaps and transmission/reception restrictions in the time, frequency or beam domain. For example, an SSB may configure or specify in combination with RRC or other signaling a DCI bit size for a DCI used to indicate information about transmission gaps associated with a particular spectrum, frequency space, channels number of subcarriers, etc. The DCI may be a fixed size or configurable via RRC or other signaling. Based on the SSB and DCI, a UE may decide to ignore a particular measurement gap that may have been configured via other methods. SSBs pay provide a bitmap indicating control information such as whether or not to skip reception of other SSBs transmitted by the same or different transmit unit in the same or different frequency spaces.

SSBs may be coded using any one of the techniques disclosed herein. They transmitted via a queue based approach depending on the resource combinations that they occupy, e.g. a first time second time third time fourth time and so forth. They may be transmitted in bursts. There may or may not be a reception response after knowing that a UE enters a cell via communication from another bs which wakes from the UE.

The following are example synchronization signal block (SSB) designs. Some designs may incorporate time/frequency elements that are conditionally utilized for uplink. Each signal, for example, PSS, SSS, PBCH, MIB, SIB, PUCCH, DCI etc, or any other signal transmitted herein, may be transmitted only on demand as necessary and if not necessary, each segment may be substituted with another one or more of PSS, SSS, PBCH, MIB, SIB, PUCCH, DCI. In some embodiments, a device may transmit SSB in multiple frequency bands, for example, at an overlapping time or non-overlapping time. In these embodiments, a device may determine to transmit information about a subsequent SSB from within a first SSB. For example, the PBCH or any one of the SIB portions may include a field which specifies a frequency or time offset, a beam, or other information which signals how and when to receive a following SSB on another band. In embodiments, a periodicity and a bitmap may be used for conveying information fields. Uplink fields may be used for SSB receiving devices to provide feedback, including CSI feedback, requests for on demand SSB portions, including control and data portions. Any other information disclosed herein may be provided on uplink to control the SSB or future SSBs. In embodiments, SSBs may be transmitted over slots which occupy both uplink and downlink symbols. In embodiments, uplink and downlink signaling may be sent on time/frequency overlapping symbols using directional beamforming. Uplink signaling may be used to activate downlink SSB indices that are not transmitted otherwise.

A device may transmit or receive separate SSBs according to traffic type, for example, one SSB may be associated with XR traffic and its frequency spread, timing and transmission offset may be associated with XR traffic parameters. Other SSBs may be transmitted by a same or different base station or other device and may convey parameters associated with different traffic types. Periodicity, frequency use and beam subset for use by a group of SSBs may be indicated via broadcast DCI type transmission or may be groupcast to a certain group of UEs which are within a beam subset and have certain matching capabilities which either the device transmitting the SSB is aware of, or another device which provides the DCI is aware of.

Beam quality reporting may be performed during SSB transmission, for example, via an index which is identifiable. This may be done based on DCI signal allocation from within the SSB or alternatively RRC signaling and reception of a certain beam or best beam pair or tuple may be employed. The beam pair or tuple may comprise beams of different types, different shapes, beams received on different frequencies, and/or may be based on beams received at the same or different times. Beam pair may be selected based on reporting potentials to network and receiving responses or determined based on receiving RRC configuration for automatic UE selection of aggregated UEs may do the measuring and reporting or BSs may do the measuring and reporting based on transmissions made by the UE. As bandwidth increases, more beams used by the UE or BS may be parabolic or other shaped beams. After determining a certain beam, for example, a parabolic beam, the BS and UE may negotiate (using a request/response) messaging scheme, a width of a beam pair. The request response procedure may negotiate a parabolic beam for uplink or downlink and another beam type for the opposite direction.

SSBs may be transmitted using orthogonal data streams. For example, if a system is configured to support two or more data streams at a given channel frequency (and/or above), the system may use two data streams independently polarized and may transmit SS blocks independent on each data stream. In other embodiments, SSBs may be alternated on each data stream and/or each SS block may be transmitted simultaneously on both data streams. In embodiments, SSB signals or individual blocks may be transmitted only on a certain data stream. For example, SSB symbol1 may be transmitted on data stream 1, SSB symbol2 may be transmitted on data stream 2, SSB symbol3 may be transmitted on data stream 1, SSB symbol4 may be transmitted on data stream 2 and so forth. Individual data streams may comprise certain control information only, while other data streams may be used for data elements. Certain information may be provided on a single data stream which indicates information, e.g. a size, position, timing, or the like of data or control information of a second data stream (which may or may not be polarized differently). Polarization may be performed according to Ultra-Wideband Terahertz Integrated Polarization Multiplexer by Gao et al. as disclosed herein by reference in its entirety.

Using polarization diversity, feedback may be provided on one or more data streams. For example, a receiver (e.g. a UE, base station, mobile station or the like), may provide RRC parameters which configured certain options, including feedback options to receive feedback as to a preferred operating frequency or band, a polarization extinction ratio, a recommended waveguide type, penetration depth, coupling gap, with of a selected bridging waveguide, a mode or phase selection quasi even and quasi odd (in phase and out of phase mode), level of mode interference, bandwidth, crosstalk measurement, crosstalk per frequency per stream, power, sample shift, rotation, transmission coefficients. Feedback and RRC parameter configuration may be interlaced or multiplexed with OFDM parameters. For example, a UE may provide feedback of an OFDM transmission multiplexed with feedback of a polarization diversity transmission (using one or more of an OFDM or polarization diversity transmit scheme). UEs and base stations may map certain QoS flows to certain transmission schemes, for example, high QoS flows may be mapped to a polarization diversity transmit scheme, while low QoS flows may be mapped to OFDM schemes. Certain DRX schemes may apply for some access schemes and not others, based on any parameter defined herein reaching a threshold value.

In examples, a UE or BS may predict a set of future beams, based on a set of beams utilized in the past at given times, locations, angles of operation, etc. beam prediction may be based on information received from other UEs, for example, via sidelink communication or via a base station. Prediction parameters for measurement and other prediction may be provided via RRC. The UE or BS may then monitor the quality of transmission or reception based on beam selection and feed back information for making future estimates and learning. N may be different depending on whether the beam prediction is made in spatial domain vs. time domain.

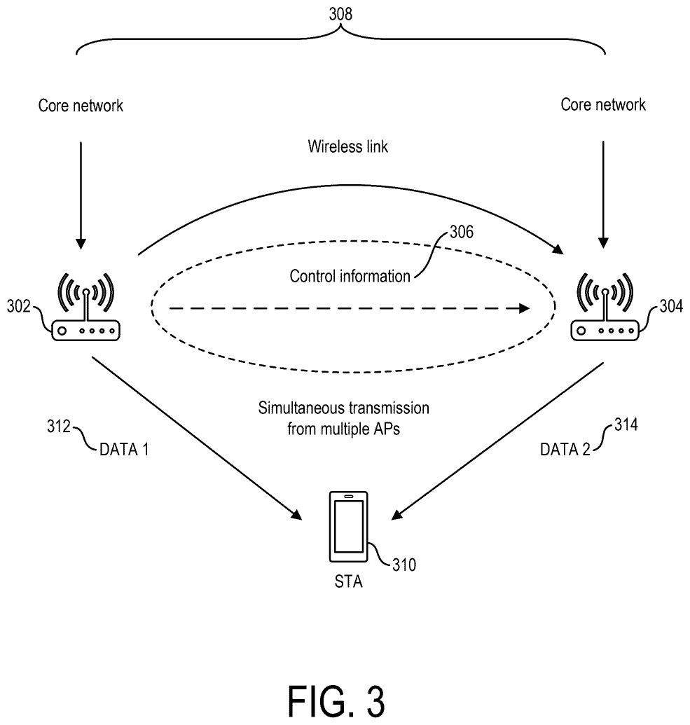

FIG. 3 is a network diagram 300 illustrating simultaneous transmission from multiple access points (APs). Wired, wireless devices or NTN devices may act as both repeater devices and secondary APs or secondary base stations which alternatively provide unique information to a mobile station. The network diagram of FIG. 3 is based on amendments to “Considerations on Joint Transmission” by Serizawa et al.

In an embodiment, control information 306 may be provided by a primary AP 302 which indicates wither the secondary AP 304 should repeat information transmitted over a wireless link between P-AP 302 and S-AP 304 and/or whether S-AP 304 should transmit unique information from the core network 308 (or another network) to the STA. The control information 306 may include: time information, beam information (which beams to use for S-AP 304 to reach the STA 310), switch information, for example information as to the radio conditions when to switch from a repeat mode to a unique data mode. One or both of the transmitters may be transmitting sensing and/or power based transmissions along with control and data transmissions. STA 310 may receive data 312 and/or data 314 from APs 302, 304. Time information may be used to specify an offset from a reference time or reference start time. In this way, S-AP 304 may act as both a repeater (which conditions are warranted) and as a unique data transmitter (again as conditions are warranted). The S-AP 304 may determine autonomously or via express signaling when to perform a repeat procedure vs when to transmit unique information. The STA 310 may indicate to either P-AP 302 or S-AP 304 a preference for repeat or unique. A STA may associate with one AP or another. There may be a channel load and/or number of STAs that exist within range of either AP that either AP uses to make a decision to act as a repeater or not. Either AP may report CQI information to the STA for forwarding to the other AP. APs may communicate such control information to one another over the wireless link, over a backhaul link, over a control link etc. it may be that aggregated links or asymmetric links are or are not employed.

UEs may communicate with various devices, e.g. devices in a space network, air network ground network, with RISs, base stations, etc. UEs may employ full duplex methods in which the UEs may be in TX communication with a first device and RX communication with a second device or may be in full duplex (including sub band full duplex or other methods) with a single device (including both TX/RX) and/or multiple devices (some TX/RX, some RX and some TX). The resources may be fully overlapping in time/frequency or partially overlapping in time/frequency. At the UE side, the UE may use beam differences to determine a threshold for establishing full duplex, in combination with network signaling. For example, the network may configure, via RRC or other signaling, thresholds for establishing full duplex communication, e.g. the network may configure time and location based information for establishing the communication, a list of devices correlated with the time and location, an angle threshold for determining whether an additional TX or RX beam should be aggregated, based on a currently used beam or set of beams for one TRP compared to a potential beam for another TRP.

Devices may be capable of capable of transmitting data and sending sensing signals simultaneously, receiving data and receiving sensing signals (e.g. signal responses or echoes of other transmitting devices). In some embodiments, device may be sensing (transmitting or receiving sensing signals) in a different direction or frequency than the data is sent or received in.

A UE may request that a base station or other device modify a directionality of an SSB, for example, by transmitting an SSB in an out of order direction, based on a request/response that may be part of the SSB itself. For example, in an uplink portion of the SSB, the base station or other device may receive an uplink request for sensing to be performed in a direction. Based on a priority included in the request, the base station may skip transmission of SSB in certain directions and may advance to an SSB transmission in the requested direction and then either backtrack and transmit the skipped directions or continue an SSB rotation beginning with the skipped direction. The base station may consider other parameters herein in a determination as to whether to process the request and/or where to continue the SSblock transmission from.

Synchronization signals may include power transmission signals at certain power level(s) based on responses receive during synchronization time periods. For example, the uplink portions of the SSBs may be utilized for both uplink data transmission and echo signal reception. This type of sensing may relate to a signature based detection procedure in terms of determining whether to apply power at a given resource per signature received in response. So, if a particular signature is receive in an echo response, then power may be increased to or above another threshold up until a maximum level is reached.

In embodiments, base stations may ascertain a time difference of arrival between other neighboring base stations via their transmissions and via reports made by intermediary UEs. For instance, if a UE is connected to two or more base stations, the UE can pass back TDOA signals to each base station for each base station to calculate timing difference between the station based on the feedback by an intermediary UE. This information may be used in determining a number of microbands to sample, a width of the microbands and/or whether to instantiate a microband SBFD sampling case.

In some embodiments, transmission reception points and/or UEs may be configured with movable antenna antennas and/or movable elements. Movable antenna elements may be configured to move in an effort to reshape wireless channels. Devices may report a number of antennas, an array size and an array configuration using a capability report. In embodiments, a configuration may be provided e.g. folding, dual scale, liquid fluidity, transformable structure, mechanically driven e.g. motor based, electronically driven, reconfigurable, etc. A time to change angle, direction, x, y, z parameter may be determined and used to determine whether a device may participate. For example, in a multi base station setup phase, a plurality of base stations may determine which base station is a primary bs and which base stations are secondary bs(s). It may be that a BS with greater reach (more power) acts as a primary bs or it may be that a BS with more or less configurable antenna capability acts as the primary bs. The determination of primary vs. secondary bs may be based on any device capability parameter disclosed herein. During coordination, devices may share more specifics about flexible antennas and antenna elements, for instance, devices may share the use characteristics, directionality, time to switch element direction(s), whether or not certain elements are scheduled at a time/frequency/beam, etc. It may be that certain base stations are selected and others are dropped (for a particular transmission or reception) based on antenna element activity. In some instances, depending on a channel quality, direction of UE/STA reception, two base stations may begin sharing data in advance of negotiated capabilities and transmission characteristics depending on whether those two BSs served a STA in a particular direction previously, or whether data indicates that a BS in a certain region can or cannot be reached at a particular channel quality level. Subsequently, after an allocation is sent by one or more BSs, to one or more mobile devices, flexible antenna elements may be varied based on the observed channel conditions as reported by BSs and/or mobile devices. BSs may make individual decisions to drop others based on flexible antenna elements performing below a threshold such that the complexity/power involved with a movable antenna transmission exceeds a threshold.

A same or different transmitter may employ a number of access points and/or a number of multiple link capable APs (that may or may not only operate on a plurality of frequency bands), wherein each device is separated in the spatial domain via movable antennas. In some embodiments a primary transmitter may send a multicast or broadcast transmission for a plurality of secondary devices to reconfigure antenna panels. For example, the primary device may provide an array comprising a field indicating an identifier of a receiving device, followed by a reconfiguration command, followed by a series of antenna movement indications. This may be done is sequence for each device being configured in the broadcast or multicast transmission. Alternatively, unicast methods may be used. Secondary devices may be configured to adjust movable antennas according to a movement trajectory of the device or antenna panel. There may be scenarios wherein the FCC allows transmission in certain frequency bands, for certain transmission priorities only. Additionally, there may be certain bands allowed at certain locations/times of data and not to exceed a power level. Before transmitting in a certain band, a device may ascertain a time of day, transmission direction, location etc. and may provide a request/receive a response indicating whether acceptable to transmit in a band. Alternatively, or in combination, for certain priority transmissions or short transmissions, a device may need not perform a request/response and may transmit immediately or after a delay.

Initial Access and Registration is the process by which a UE connects to the network and registers to obtain service access. The process may begin with the UE scanning for available cells and selecting the best one based on signal quality. It then performs a Random Access Channel (RACH) procedure to establish a connection with the selected gNodeB (gNB). This process involves the UE sending a random access preamble to the gNB to request resources for initial access, handover, or re-establishing a connection and may include an indication of one or more sequence selections, e.g. a zadoff chu sequence, gold sequence or other sequence. Dedicated parameters may be sent in RACH or with a RACH preamble, for example one or more components of the On Demand Multimedia Priority Service (OD-MPS) code.

If the UE is out of network access and cannot connect to an gNB, it may not directly use the OD-MPS features as they rely on the network's infrastructure. The absence of network access implies that the UE may not communicate with the core network, thus hindering its ability to transmit or receive prioritized multimedia services through traditional cellular methods.

The UE may use alternative communication methods such as sidelink or Wi-Fi, though this depends on the capabilities of the UE and the specific implementations of the network services.

Sidelink or device-to-device (D2D) may be used for direct communication between UEs, providing an alternative means of maintaining communication in the absence of gNB connectivity.

Wi-Fi: The UE may switch to Wi-Fi for connectivity if cellular service is unavailable. Many modern UEs support seamless transition between cellular networks and Wi-Fi, allowing for continued data and voice services through available Wi-Fi networks.

High complexity UEs, with advanced features and capabilities, are better suited for delivering reliable and efficient OD-MPS. They handle higher data rates and complex network conditions, ensuring critical communications are maintained with high quality and minimal interruption. Low complexity UEs, especially those with only TDD functionality, may still provide OD-MPS but may experience higher latency and lower throughput, impacting the reliability of priority communications during emergencies.

If a UE does not have a service subscription with any service provider and needs to make an emergency call (e.g., 911), the initial access and registration procedures may involve emergency registration or special Non-Access Stratum (NAS) signaling. The network, referencing 3GPP TS 24.501, for example, version 18.6.0 which is incorporated herein by reference in its entirety, assesses this request against special access criteria and temporarily authorizes the UE for high-priority services under emergency conditions.

If a UE has a service subscription with a network service provider but is not pre-authorized by government authorities for MPS and is seeking OD-MPS, it may perform the following procedures, which entail some modifications to the existing 3GPP procedures:

What is claimed is:

1. A multiple subscriber identity module (multi-SIM) compliant user equipment (UE), comprising:
a first SIM;
a second SIM which is different than the first SIM;
a transceiver configured to receive a synchronization signal block (SSB) associated with a first network, based on information of the first SIM;
the transceiver configured to perform initial access and to establish a connection with the first network;
the transceiver configured to transmit a data signal for processing by a second network associated with the second SIM, wherein the signal is transmitted based on the established connection with the first network;
wherein communication with the first network and the second network is based on an overlap in an initial network handshake with the first network and the second network.

2. The multi-SIM compliant UE of claim 1, wherein the UE does not monitor for an SSB on the second network.

3. The multi-SIM compliant UE of claim 1, wherein the overlap in the initial network handshake with the first network and the second network includes an overlap in synchronization signal reception.
